(19) United States
(12) Patent Application Publication
(10) Pub. No.: US 2025/0384304 A1
(43) Pub. Date: Dec. 18, 2025

(54) SYSTEMS AND METHODS FOR INTEGRATING MULTIPLE MODEL SIMULATIONS

(71) Applicant: Optum, Inc., Minnetonka, MN (US)

(72) Inventors: John E Krech, Minneapolis, MN (US); David C Barry, Richfield, MN (US); Edward A Smeal, Willow Grove, PA (US)

(21) Appl. No.: 18/740,788

(22) Filed: Jun. 12, 2024

(51) Int. Cl. G06N 5/022

(52) U.S. Cl. CPC G06N 5/022

(57) ABSTRACT

Various embodiments of the present disclosure provide methods, apparatus, systems, computing devices, computing entities, and/or the like for integrating traditionally disparate machine learning models by determining a plurality of changes to a first variable based on a plurality of changes to one or more second variables, determining estimated effects in a first variable model based on an optimization of the one or more second variables, generating a plurality of first prediction outputs based on the estimated effects, and generating a set of combined prediction outputs by combining the plurality of first prediction outputs with a plurality of second prediction outputs that is associated with estimated effects in the one or more second variables.

### BACKGROUND

Various embodiments of the present disclosure address technical challenges related to simulation modeling and provide solutions to address the predictive shortcomings of existing simulation analysis technologies.

Statistical techniques, such as key driver analysis, may be applied in various domain fields, such as in the healthcare industry, for testing and estimating observational and/or causal relations based on a combination of statistical data and qualitative assumptions. For example, machine learning models that are based on probabilistic structural equation models (PSEMs) may be used to prioritize initiatives to maximize results based on interpretations from customer experience data for both strategic and tactical decision makers. A traditional approach for performing multi-quadrant analysis may comprise generating a plurality of PSEMs around a breakout variable. However, each PSEM comprises a separate and independent model with no ability to simultaneously generate simulations and predictions across multiple PSEMs (e.g., quadrants of the breakout variable). As such, the predictive capability of PSEM is limited with respect to holistic, multi-parameter, prediction spaces. The traditional approach is also not representative of real-world scenarios where a plurality of interactions may exist between various model components.

Various embodiments of the present disclosure make important contributions to traditional simulation modeling techniques by addressing these technical challenges, among others.

### BRIEF SUMMARY

In general, various embodiments of the present disclosure provide methods, apparatus, systems, computing devices, computing entities, and/or the like for integrating multiple, traditionally disparate, machine learning models.

Various embodiments of the present disclosure make important technical contributions to machine learning by extracting and isolating contributions from collinearity associated with a plurality of independent predictive machine learning models and reassembling the contributions such that the plurality of independent predictive machine learning models or predictions generated by the plurality of independent predictive machine learning models may be efficiently combined. As described herein, a multiple-model machine learning architecture may comprise tiers of individual predictive machine learning models that are trained to generate various distinct prediction targets at a granular level based on tier level. Accordingly, by identifying collinearity and allocating impact due to the collinearity, the techniques described herein enable the integration of traditionally disparate predictive machine learning models to generate holistic predictions that capture data feature behaviors and relationships across various tiers of the multiple-model machine learning architecture.

In some embodiments, a computer-implemented method comprises determining, by one or more processors, a plurality of first-level variable effects on a target variable based on a plurality of first-level variable changes to a plurality of first-level variables; determining, by the one or more processors, one or more first estimated effects on the target variable by configuring a first set of one or more first-level variables of the plurality of first-level variables based on the plurality of first-level variable effects; generating, by the one or more processors and using a target variable machine learning model, one or more first prediction outputs based on the one or more first estimated effects; generating, by the one or more processors, a first set of combined prediction outputs by combining the one or more first prediction outputs with one or more second prediction outputs that are generated based on one or more second estimated effects on the target variable with respect to one or more quadrant variables; and initiating, by the one or more processors, the performance of one or more prediction-based actions based on the first set of combined prediction outputs.

In some embodiments, a computing system comprises memory and one or more processors communicatively coupled to the memory, the one or more processors configured to determine a plurality of first-level variable effects on a target variable based on a plurality of first-level variable changes to a plurality of first-level variables; determine one or more first estimated effects on the target variable by configuring a first set of one or more first-level variables of the plurality of first-level variables based on the plurality of first-level variable effects; generate, using a target variable machine learning model, one or more first prediction outputs based on the one or more first estimated effects; generate a first set of combined prediction outputs by combining the one or more first prediction outputs with one or more second prediction outputs that are generated based on one or more second estimated effects on the target variable with respect to one or more quadrant variables; and initiate the performance of one or more prediction-based actions based on the first set of combined prediction outputs.

In some embodiments, one or more non-transitory computer-readable storage media includes instructions that, when executed by one or more processors, cause the one or more processors to determine a plurality of first-level variable effects on a target variable based on a plurality of first-level variable changes to a plurality of first-level variables; determine one or more first estimated effects on the target variable by configuring a first set of one or more first-level variables of the plurality of first-level variables based on the plurality of first-level variable effects; generate, using a target variable machine learning model, one or more first prediction outputs based on the one or more first estimated effects; generate a first set of combined prediction outputs by combining the one or more first prediction outputs with one or more second prediction outputs that are generated based on one or more second estimated effects on the target variable with respect to one or more quadrant variables; and initiate the performance of one or more prediction-based actions based on the first set of combined prediction outputs.

### BRIEF DESCRIPTION OF THE DRAWINGS

FIG. 1 provides an example overview of an architecture in accordance with some embodiments of the present disclosure.

FIG. 2 provides an example predictive data analysis computing entity in accordance with some embodiments of the present disclosure.

FIG. 3 provides an example client computing entity in accordance with some embodiments of the present disclosure.

FIG. 4 is a flowchart diagram of an example process for integrating disparate machine learning models in accordance with some embodiments of the present disclosure.

FIG. 5 is an operational example of a prediction output in accordance with some embodiments of the present disclosure.

FIG. 6 is a flowchart diagram of an example process for generating first-level quadrant variable-based prediction outputs in accordance with some embodiments of the present disclosure.

FIG. 7 is a flowchart diagram of an example process for generating second-level variable-based prediction outputs in accordance with some embodiments of the present disclosure.

FIG. 8 is a flowchart diagram of an example process for generating second-level quadrant variable-based prediction outputs in accordance with some embodiments of the present disclosure.

FIG. 9 is an operational example of sets of combined prediction outputs in accordance with some embodiments of the present disclosure.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### I. COMPUTER PROGRAM PRODUCTS, METHODS, AND COMPUTING ENTITIES

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

A non-volatile computer-readable storage medium may include a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

A volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. EXAMPLE FRAMEWORK

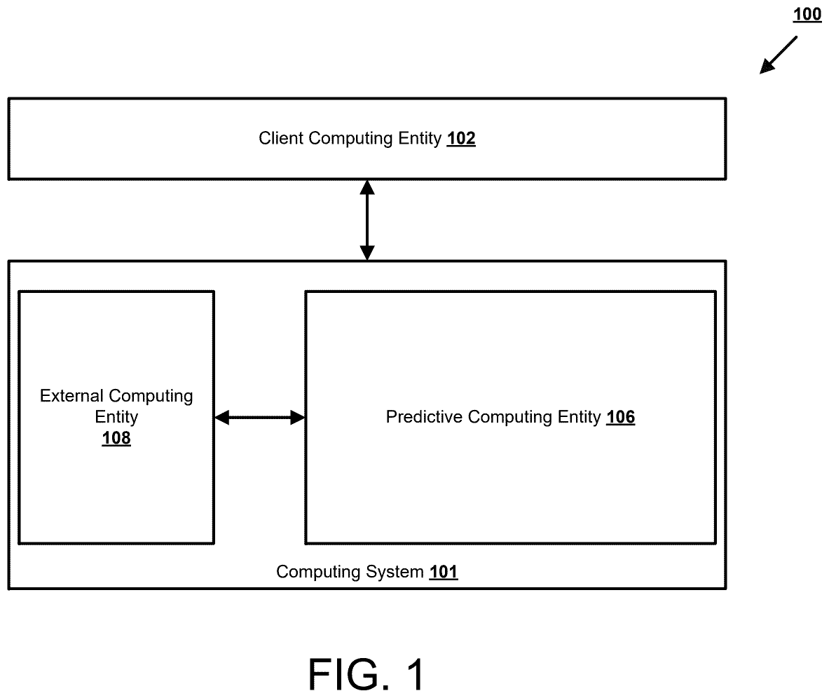

FIG. 1 provides an example overview of an architecture 100 in accordance with some embodiments of the present disclosure. The architecture 100 includes a computing system 101 configured to receive predictive data analysis requests from one or more client computing entity 102, process the predictive data analysis requests to generate predictions, provide the generated predictions to the one or more client computing entity 102, and automatically initiate performance of prediction-based actions based on the generated predictions. The example architecture 100 may be used in a plurality of domains and not limited to any specific application as disclosed herewith. The plurality of domains may include banking, healthcare, industrial, manufacturing, education, retail, to name a few.

An example of a prediction-based action that may be performed using the computing system 101 comprises receiving a request for recommending improvements to a quality of a product or service, predicting associated actions or resources that may be prioritized to improve the quality of the product or service, and displaying the improvements and predicted actions or resources on a user interface. Other examples of prediction-based actions comprise generating a diagnostic report, displaying/providing a resource-based action (e.g., allocation of resource), generating, and/or executing action scripts, generating alerts or reminders, or generating one or more electronic communications based on the predicted actions or resources.

In accordance with various embodiments of the present disclosure, a plurality of prediction outputs generated by various tiers of machine learning models are combined. Each of the machine learning models of the various tiers may be associated with a variable that uniquely affects a target variable that is associated with the plurality of prediction outputs. Accordingly, a plurality of independent machine learning models may be combined to provide holistic predictions that capture data feature behaviors and relationships across the various tiers of machine learning models. This technique will lead to higher accuracy of performing predictive operations as needed on data comprising multi-dependent variables. In doing so, the techniques described herein improve efficiency and speed of training predictive machine learning models, thus reducing the number of computational operations needed and/or the amount of training data entries needed to train predictive machine learning models.

In some embodiments, the computing system 101 may communicate with at least one of the client computing entity 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may include a predictive data analysis computing entity 106 and one or more external computing entities 108. The predictive data analysis computing entity 106 and/or one or more external computing entities 108 may be individually and/or collectively configured to receive predictive data analysis requests from one or more client computing entity 102, process the predictive data analysis requests to generate predictions corresponding to the predictive data analysis requests, provide the generated predictions to the one or more client computing entity 102, and automatically initiate performance of prediction-based actions based on the generated predictions.

For example, as discussed in further detail herein, the predictive data analysis computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data analysis and/or training tasks. The storage subsystem may include one or more storage units, such as multiple distributed storage units that are connected through a computer network. Each storage unit in the respective computing entities may store at least one of one or more data assets and/or one or more data about the computed properties of one or more data assets. Moreover, each storage unit in the storage systems may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

In some embodiments, the predictive data analysis computing entity 106 and/or one or more external computing entities 108 are communicatively coupled using one or more wired and/or wireless communication techniques. The respective computing entities may be specially configured to perform one or more steps/operations of one or more techniques described herein. By way of example, the predictive data analysis computing entity 106 may be configured to train, implement, use, update, and evaluate machine learning models in accordance with one or more training and/or prediction operations of the present disclosure. In some examples, the external computing entities 108 may be configured to train, implement, use, update, and evaluate machine learning models in accordance with one or more training and/or prediction operations of the present disclosure.

In some example embodiments, the predictive data analysis computing entity 106 may be configured to receive and/or transmit one or more datasets, objects, and/or the like from and/or to the external computing entities 108 to perform one or more steps/operations of one or more techniques (e.g., data analysis techniques, data optimization, data modeling techniques, data pipelining techniques, and/or the like) described herein. The external computing entities 108, for example, may include and/or be associated with one or more entities that may be configured to receive, transmit, store, manage, and/or facilitate datasets, such as a dataset including enterprise data, operational data, and/or the like. The external computing entities 108, for example, may include data sources that may provide such datasets, and/or the like to the predictive data analysis computing entity 106 which may leverage the datasets to perform one or more steps/operations of the present disclosure, as described herein. In some examples, the datasets may include an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive data analysis computing entity 106 to obtain and aggregate data for a prediction domain.

In some example embodiments, the predictive data analysis computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive data analysis computing entity 106, which may leverage the trained machine learning model to perform one or more prediction steps/operations of the present disclosure. In some examples, feedback (e.g., evaluation data, ground truth data, etc.) from the use the of the machine learning model may be recorded by the predictive data analysis computing entity 106. In some examples, the feedback may be provided to the one or more external computing entities 108 to continuously train the machine learning model over time. In some examples, the feedback may be leveraged by the predictive data analysis computing entity 106 to continuously train the machine learning model over time. In this manner, the computing system 101 may perform, via one or more combinations of computing entities, one or more prediction, training, and/or any other machine learning-based techniques of the present disclosure.

### A. EXAMPLE PREDICTIVE DATA ANALYSIS COMPUTING ENTITY

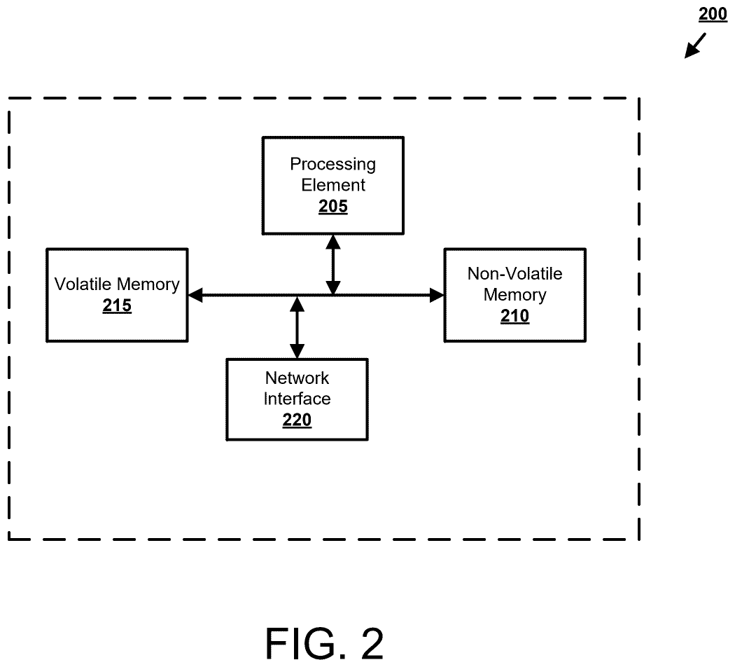

FIG. 2 provides an example computing entity 200 in accordance with some embodiments of the present disclosure. The computing entity 200 is an example of the predictive data analysis computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive data analysis computing entity 106, etc.) may train and use one or more machine learning models described herein. In other embodiments, a first computing entity (e.g., predictive data analysis computing entity 106, etc.) may use one or more machine learning models that may be trained by a second computing entity (e.g., external computing entity 108) communicatively coupled to the first computing entity. The second computing entity, for example, may train one or more of the machine learning model(s) described herein, and subsequently provide the trained machine learning model(s) (e.g., optimized parameters, weights, code sets, etc.) to the first computing entity over a network.

As shown in FIG. 2, in some embodiments, the predictive data analysis computing entity 106 may include, or be in communication with, one or more processing elements 205 (also referred to as processor(s), processing circuitry, and/or similar terms used herein interchangeably) that communicate with other elements within the predictive data analysis computing entity 106 via a bus, for example. As will be understood, the processing elements 205 may be embodied in a number of different ways.

For example, the processing elements 205 may be embodied as one or more complex programmable logic devices (CPLDs), microprocessors, multi-core processors, coprocessing entities, application-specific instruction-set processors (ASIPs), microcontrollers, and/or controllers. Further, the processing elements 205 may be embodied as one or more other processing devices or circuitry. The term circuitry may refer to an entirely hardware embodiment or a combination of hardware and computer program products. Thus, the processing elements 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing elements 205 may be configured for a particular use or configured to execute instructions stored in volatile or non-volatile media or otherwise accessible to the processing elements 205. As such, whether configured by hardware or computer program products, or by a combination thereof, the processing elements 205 may be capable of performing steps or operations according to embodiments of the present disclosure when configured accordingly.

In some embodiments, the computing entity 200 may further include, or be in communication with, non-volatile media (also referred to as non-volatile storage, memory, memory storage, memory circuitry, and/or similar terms used herein interchangeably). In some embodiments, the non-volatile media may include one or more non-volatile memory 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile media may store databases, database instances, database management systems, data, applications, programs, program modules, scripts, code (e.g., source code, object code, byte code, compiled code, interpreted code, machine code, etc.) that embodies one or more machine learning models or other computer functions described herein, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In some embodiments, the computing entity 200 may further include, or be in communication with, volatile media (also referred to as volatile storage, memory, memory storage, memory circuitry, and/or similar terms used herein interchangeably). In some embodiments, the volatile media may also include one or more volatile memory 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, code (e.g., source code, object code, byte code, compiled code, interpreted code, machine code, etc.) that embodies one or more machine learning models or other computer functions described herein, executable instructions, and/or the like being executed by, for example, the processing elements 205. Thus, the databases, database instances, database management systems, data, applications, programs, program modules, scripts, code (e.g., source code, object code, byte code, compiled code, interpreted code, machine code, etc.) that embodies one or more machine learning models or other computer functions described herein, executable instructions, and/or the like may be used to control certain aspects of the operation of the computing entity 200 with the assistance of the processing elements 205 and operating system.

As indicated, in some embodiments, the computing entity 200 may also include one or more network interfaces 220 for communicating with various computing entities (e.g., the one or more client computing entity 102, external computing entities, etc.), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the predictive data analysis computing entity 106 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may include, or be in communication with, one or more input elements, such as a keyboard input, a mouse input, a touch screen/display input, motion input, movement input, audio input, pointing device input, joystick input, keypad input, and/or the like. The computing entity 200 may also include, or be in communication with, one or more output elements (not shown), such as audio output, video output, screen/display output, motion output, movement output, and/or the like.

### B. EXAMPLE CLIENT COMPUTING ENTITY

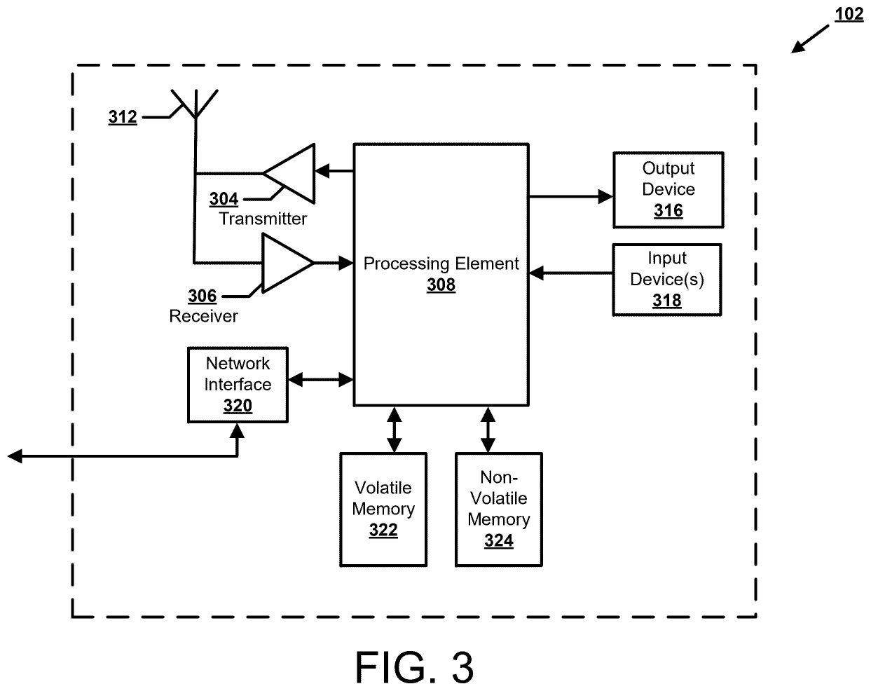

FIG. 3 provides an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entity 102 may be operated by various parties. As shown in FIG. 3, the client computing entity 102 may include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the computing entity 200. In some embodiments, the client computing entity 102 may operate in accordance with multiple wireless communication standards and protocols, such as UMTS, CDMA2000, 1xRTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the computing entity 200 via a network interface 320.

Via these communication standards and protocols, the client computing entity 102 may communicate with various other entities using mechanisms such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 may also download code, changes, add-ons, and updates, for instance, to its firmware, software (e.g., including executable instructions, applications, program modules), and operating system.

According to some embodiments, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In some embodiments, the location module may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the DecimalDegrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface (that may include an output device 316 (e.g., display, speaker, tactile instrument, etc.) coupled to a processing clement 308) and/or a user input interface (coupled to a processing clement 308). For example, the user interface may be a user application, browser, user interface, and/or similar words used herein interchangeably executing on and/or accessible via the client computing entity 102 to interact with and/or cause display of information/data from the computing entity 200, as described herein. The user input interface may comprise any of a plurality of input devices 318 (or interfaces) allowing the client computing entity 102 to receive code and/or data, such as a keypad (hard or soft), a touch display, voice/speech or motion interfaces, or other input device. In some embodiments including a keypad, the keypad may include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface may be used, for example, to activate or deactivate certain functions, such as screen savers and/or sleep modes.

The client computing entity 102 may also include volatile memory 322 and/or non-volatile memory 324, which may be embedded and/or may be removable. For example, the non-volatile memory 324 may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory 322 may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile memory may store databases, database instances, database management systems, data, applications, programs, program modules, scripts, code (e.g., source code, object code, byte code, compiled code, interpreted code, machine code, etc.) that embodies one or more machine learning models or other computer functions described herein, executable instructions, and/or the like to implement the functions of the client computing entity 102. As indicated, this may include a user application that is resident on the client computing entity 102 or accessible through a browser or other user interface for communicating with the computing entity 200 and/or various other computing entities.

In another embodiment, the client computing entity 102 may include one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity, such as an Amazon Echo, Amazon Echo Dot, Amazon Show, Google Home, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### III. EXAMPLES OF CERTAIN TERMS

In some embodiments, the term “target variable” refers to a data construct that describes an objective or desired outcome. For example, a target variable may be representative of a score or measurement that is based on one or more first-level variables. In some embodiments, a value of a target variable is dependent on one or more first-level variables.

In some embodiments, the term “variable effect” refers to an influence on a first variable that is caused by changing a second variable. For example, a first-level variable may affect a target variable if changed. In another example, changing a second-level variable that affects the first-level variable may in turn affect the target variable.

In some embodiments, the term “first-level variable” refers to a data construct that describes a variable that contributes to or affects a value of a target variable.

In some embodiments, the term “first-level variable change” refers to a change of a first-level variable. For example, a first-level variable change may comprise an operation that varies a first-level variable for determining a first-level variable effect that is caused by varying the first-level variable.

In some embodiments, the term “estimated effect” refers to a variable effect that comprises a highest relative degree of variable effect on a first variable that is caused by changing a second variable to a given value among a plurality of values. In some embodiments, a estimated effect comprises a highest likelihood or probability of success. In some embodiments, a estimated effect comprises a cost that acts as a counter-balance. According to various embodiments of the present disclosure, one or more estimated effects on a first variable are determined by configuring one or more second variables of a plurality of second variables based on a plurality of variable effects on the first variable that are caused by changing the second variables.

In some embodiments, the term “optimizing” refers to an operation for determining one or more values among a plurality of values for one or more first variables that cause a highest relative degree of variable effect (e.g., estimated effect) on a second variable among a plurality of values for each of the one or more first variables. For example, the highest relative degree of variable effect on the second variable may be associated with a highest amount of desired effect on the second variable.

In some embodiments, the term “prediction output” refers to a data construct that describes an output generated by a machine learning model. According to various embodiments of the present disclosure, one or more first prediction outputs are generated, using a target variable machine learning model, based on the one or more first estimated effects. In some embodiments, a prediction output comprises a simulation that is based on one or more first estimated effects.

In some embodiments, the term “set of combined prediction outputs” refers to a data construct that describes a combination of one or more first prediction outputs with one or more of second or more prediction outputs. For example, a set of combined prediction outputs may be generated by combining one or more first prediction outputs that are generated based on one or more first estimated effects on a target variable with one or more second prediction outputs that are based on one or more second estimated effects on the target variable with respect to one or more quadrant variables. In some embodiments, combining one or more first prediction outputs with one or more second prediction outputs may comprise associating the one or more first prediction outputs with the one or more second prediction outputs based on one or more relationships between one or more variables that are associated with the one or more first prediction outputs and one or more variables that are associated with the one or more second prediction outputs. According to various embodiments of the present disclosure, the performance of one or more prediction-based actions is initiated based on a set of combined prediction outputs. In some embodiments, the performance of one or more prediction-based actions is initiated based on a simulation data object that is generated based on one or more of a first set of combined prediction outputs or a second set of combined prediction outputs.

In some embodiments, the term “quadrant variable” refers to a data construct that describes a segment of a target variable, also known as a breakout variable. For example, a quadrant variable may be associated with a subset of data that is associated with a target variable.

In some embodiments, the term “second-level variable” refers to a data construct that describes a variable that contributes to or affects a value of a first-level variable.

In some embodiments, the term “second-level variable change” refers to a change of a second-level variable. For example, a second-level variable change may comprise an operation that varies a second-level variable for determining a second-level variable effect that is caused by varying the second-level variable.

In some embodiments, the term “target variable machine learning model” refers to a data construct that describes parameters, hyperparameters, and/or defined operations of a machine learning model that is configured to generate one or more prediction outputs that are associated with a target variable. In some embodiments, a target variable machine learning model is a probabilistic structural equation model (PSEM). For example, the PSEM may define a set of associations among a set of variables. In some embodiments, a target variable machine learning model is configured to determine one or more relationships between one or more first-level variables and a target variable. In some examples, each of the associations and/or variablevariables may be weighted by a plurality of learned coeffects. The learned coeffects may be configured through one or more training operations, such as supervised or unsupervised learning of training values for one or more first-level variables and a target variable to identify patterns such as clusters associated with the associations and/or variables. According to various embodiments of the present disclosure, a target variable machine learning model is configured to generate one or more prediction outputs based on one or more estimated effects on a target variable. For example, a prediction output generated by a target variable machine learning model may comprise a value of a target variable that is determined, using one or more trained parameters, based on an optimization of one or more first-level variables based on one or more first-level variable effects on the target variable, wherein the one or more first-level variable effects are identified by varying the one or more first-level variables. In some embodiments, a target variable machine learning model is associated with Bayesian network analysis and is trained to determine an inference variable value based on one or more input variable values. In some embodiments, a target variable machine learning model comprises a probabilistic structural equation model, a supervised machine learning model, or an unsupervised machine learning model.

In some embodiments, the term “first-level variable machine learning model” refers to a data construct that describes parameters, hyperparameters, and/or defined operations of a machine learning model that is configured to generate one or more prediction outputs that are associated with a first-level variable. In some embodiments, a first-level variable machine learning model is a PSEM. For example, the PSEM may define a set of associations among a set of variables. In some embodiments, a first-level variable machine learning model is configured to determine one or more relationships between one or more second-level variables and a first-level variable. In some examples, each of the associations and/or variables may be weighted by a plurality of learned coeffects. The learned coeffects may be configured through one or more training operations, such as supervised or unsupervised learning of training values for one or more second-level variables and a first-level variable to identify patterns such as clusters associated with the associations and/or variables. According to various embodiments of the present disclosure, a first-level variable machine learning model is configured to generate one or more prediction outputs based on one or more estimated effects on a first-level variable. For example, a prediction output generated by a first-level variable machine learning model may comprise a value of a first-level variable that is determined, using one or more trained parameters, based on an optimization of one or more second-level variables based on one or more second-level variable effects on the first-level variable, wherein the one or more second-level variable effects are identified by varying the one or more second-level variables. In some embodiments, a first-level variable machine learning model is associated with Bayesian network analysis and is trained to determine an inference variable value based on one or more input variable values. In some embodiments, a first-level variable machine learning model comprises a probabilistic structural equation model, a supervised machine learning model, or an unsupervised machine learning model.

In some embodiments, the term “first-level quadrant machine learning model” refers to a data construct that describes parameters, hyperparameters, and/or defined operations of a machine learning model that is configured to generate one or more prediction outputs that are associated with a target variable and specific to a quadrant variable. In some embodiments, a first-level quadrant variable machine learning model is a PSEM. For example, the PSEM may define a set of associations among a set of variables. In some embodiments, a first-level quadrant machine learning model is configured to determine one or more relationships between one or more quadrant variables, one or more first-level variables, and a target variable. In some examples, each of the associations and/or variables may be weighted by a plurality of learned coeffects. The learned coeffects may be configured through one or more training operations, such as supervised or unsupervised learning of training values for one or more quadrant variables, one or more first-level variables, and a target variable to identify patterns such as clusters associated with the associations and/or variables. According to various embodiments of the present disclosure, a first-level quadrant variable machine learning model is configured to generate one or more prediction outputs based on one or more estimated effects on a target variable with respect to a quadrant variable. For example, a prediction output generated by a first-level quadrant variable machine learning model may comprise a value of a target variable that is specific to a quadrant variable and determined, using one or more trained parameters, based on an optimization of one or more first-level variables based on one or more first-level variable effects on the target variable, wherein the one or more first-level variable effects are identified by varying the one or more first-level variables. In some embodiments, a first-level quadrant variable machine learning model is associated with Bayesian network analysis and is trained to determine an inference variable value based on one or more input variable values (e.g., in view of a quadrant variable). In some embodiments, a first-level quadrant variable machine learning model comprises a probabilistic structural equation model, a supervised machine learning model, or an unsupervised machine learning model.

In some embodiments, the term “second-level quadrant machine learning model” refers to a data construct that describes parameters, hyperparameters, and/or defined operations of a machine learning model that is configured to generate one or more prediction outputs that are associated with a first-level variable and specific to a quadrant variable. In some embodiments, a second-level quadrant variable machine learning model is a PSEM. For example, the PSEM may define a set of associations among a set of variables. In some embodiments, a second-level quadrant machine learning model is configured to determine one or more relationships between one or more quadrant variables, one or more second-level variables, and a first-level variable. In some examples, each of the associations and/or variables may be weighted by a plurality of learned coeffects. The learned coeffects may be configured through one or more training operations, such as supervised or unsupervised learning of training values for one or more quadrant variables, one or more second-level variables, and a first-level variable to identify patterns such as clusters associated with the associations and/or variables. According to various embodiments of the present disclosure, a second-level quadrant variable machine learning model is configured to generate one or more prediction outputs based on one or more estimated effects on a first-level variable with respect to a quadrant variable. For example, a prediction output generated by a second-level quadrant variable machine learning model may comprise a value of a first-level variable that is specific to a quadrant variable and determined, using one or more trained parameters, based on an optimization of one or more second-level variables based on one or more second-level variable effects on the first-level variable, wherein the one or more second-level variable effects are identified by varying the one or more second-level variables. In some embodiments, a second-level quadrant variable machine learning model is associated with Bayesian network analysis and is trained to determine an inference variable value based on one or more input variable values (e.g., in view of a quadrant variable). In some embodiments, a second-level quadrant variable machine learning model comprises a probabilistic structural equation model, a supervised machine learning model, or an unsupervised machine learning model.

### IV. OVERVIEW

Various embodiments of the present disclosure make important technical contributions to machine learning that address the efficiency and reliability shortcomings of existing machine learning modeling techniques. For example, some techniques of the present disclosure improve the predictive accuracy of predictive machine learning models used in generating predictions on a target variable based on a plurality of independent models or predictions on a plurality of independent variables (e.g., first-level variables and second-level variables) that affect the target variable. To do so, contributions due to collinearity that are associated with a plurality of independent predictive machine learning models are identified and reassembled such that the plurality of independent predictive machine learning models or predictions generated by the plurality of independent predictive machine learning models may be efficiently combined. By doing so, some of the techniques of the present disclosure improve the training speed and training efficiency of training predictive machine learning models while improving the predictive performance of the resulting models.

It is well-understood in the relevant art that there is typically a tradeoff between predictive accuracy and training speed, such that it is trivial to improve training speed by reducing predictive accuracy. Thus, the challenge is to improve training speed without sacrificing predictive accuracy through innovative machine learning model architectures. Accordingly, some of the techniques of the present disclosure that improve predictive accuracy without harming training speed, such as the techniques described herein, enable improving training speed given an improved predictive accuracy. In doing so, some of the techniques described herein improve efficiency and speed of training predictive machine learning models, thus reducing the number of computational operations needed and/or the amount of training data entries needed to train predictive machine learning models. Accordingly, some of the techniques described herein improve the computational efficiency, storage-wise efficiency, and/or speed of training machine learning models, while improving the model's predictive performance.

Various embodiments of the present disclosure improve predictive accuracy of predictive machine learning models by extracting and isolating contributions from collinearity associated with a plurality of independent predictive machine learning models and reassembling the contributions such that the plurality of independent predictive machine learning models or predictions generated by the plurality of independent predictive machine learning models may be efficiently combined. As described herein, a multiple-model machine learning architecture may comprise tiers of individual predictive machine learning models that are trained to generate various distinct prediction targets at a granular level based on tier level. For example, predictive machine learning models in a first upper tier may be trained to generate a target prediction and first-level predictions that are associated with first-level variables that affect the target prediction. In a further example, a second successive lower tier may comprise one or more predictive machine learning models that are trained to generate predictions that are associated with second-level variables that affect the first-level predictions. As such, each lower tier in a multiple-model machine learning architecture may comprise predictive machine learning models that generate predictions that are related to variables associated with predictions of predictive machine learning models in upper tiers. For this reason, it is important to have techniques available to handle collinearity and allocate impact due to the collinearity, otherwise, predictive machine learning models in a multiple-model machine learning architecture may over-or underestimate the impact of a certain variables. Furthermore, without the techniques disclosed herewith, a plurality of related but independent predictive machine learning models are resolved to a siloed approach that fails to integrate insights from the plurality of predictive machine learning models.

In accordance with various embodiments of the present disclosure, a plurality of prediction outputs generated by various tiers of machine learning models are combined by deconstructing the machine learning models and reassembling their outputs. Each of the machine learning models of the various tiers may be associated with a variable that uniquely affects a target variable that is associated with the plurality of prediction outputs. Accordingly, a plurality of independent machine learning models may be integrated to provide holistic predictions that capture data feature behaviors and relationships across the various tiers of machine learning models. In this manner, some of the techniques of the present disclosure, improve accuracy of performing predictive operations as needed on data comprising multi-dependent variables. Moreover, the techniques of the present disclosure may be applied to simulate collinearity to enable the integration of multiple, separate, and independent models. This, in turn, repurposes traditionally disparate machine learning models as building blocks in a multi-model architecture that simultaneously generates predictions across each of the models that are holistically derived from a plurality of collinear variables. By doing so, the techniques of the present disclosure may provide an improvement that is rooted in machine learning and address the technical challenge of handling multi-factor interactions within a complex prediction domain.

Moreover, some of the techniques (e.g., the data optimization techniques, data analysis techniques, data modeling techniques, data pipelining techniques, etc.) of the present disclosure may be applied to improve efficiency and speed of training predictive machine learning models. This, in turn, reduces the number of computational operations needed and/or the amount of training data entries needed to train predictive machine learning models. Accordingly, the techniques described herein improve the computational efficiency, storage-wise efficiency, and/or speed of training predictive machine learning models. Other technical improvements and advantages may be realized by one of ordinary skill in the art.

Examples of technologically advantageous embodiments of the present disclosure include: (i) data collinearity techniques for integrating traditionally disparate machine learning models, (ii) data optimization techniques for generating improved predictions, (iii) predictive machine learning model pipelining techniques for improving model accuracy while reducing computational resource usage, among others. Other technical improvements and advantages may be realized by one of ordinary skill in the art.

### V. EXAMPLE SYSTEM OPERATIONS

As indicated, various embodiments of the present disclosure make important technical contributions to multiple-model machine learning by extracting and isolating contributions from collinearity associated with a plurality of independent predictive machine learning models and reassembling the contributions such that the plurality of independent predictive machine learning models or predictions generated by the plurality of independent predictive machine learning models may be efficiently combined.

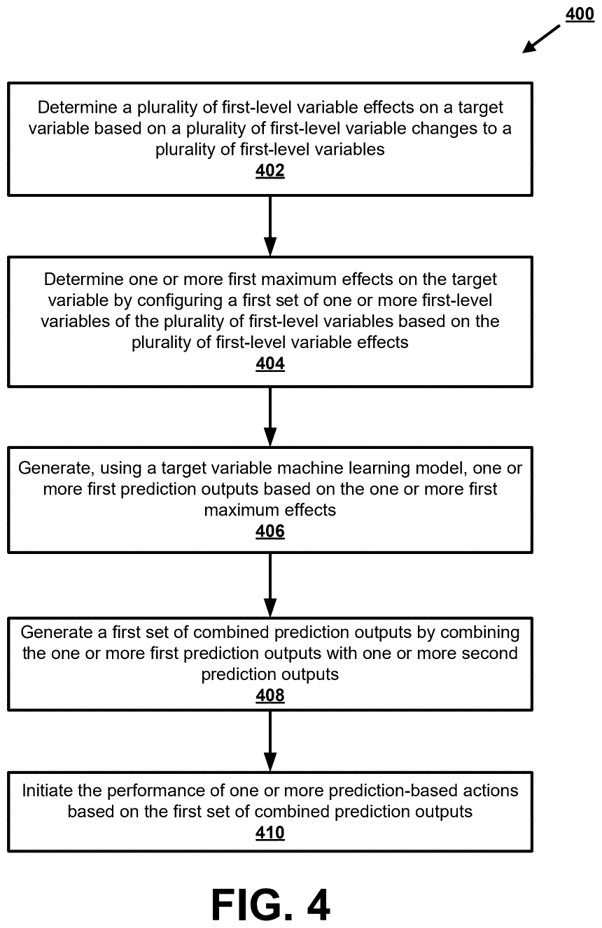

FIG. 4 is a flowchart diagram of an example process 400 for integrating disparate machine learning models in accordance with some embodiments of the present disclosure.

In some embodiments, the process 400 begins at step/operation 402 when the computing system 101 determines a plurality of first-level variable effects on a target variable based on a plurality of first-level variable changes to a plurality of first-level variables.

In some embodiments, a target variable describes an objective or desired outcome. For example, a target variable may be representative of a score or measurement that is based on one or more first-level variables. In some embodiments, a value of a target variable is dependent on one or more first-level variables.

In some embodiments, a variable effect refers to an influence on a first variable that is caused by changing a second variable. For example, a first-level variable may affect a target variable if changed.

In some embodiments, a first-level variable describes a variable that contributes to or affects a value of a target variable.

In some embodiments, a first-level variable change comprises a change of a first-level variable. For example, a first-level variable change may comprise an operation that varies a first-level variable for determining a first-level variable effect that is caused by varying the first-level variable.

In some embodiments, the plurality of first-level variable changes may be determined based on stored values of the plurality of first-level variables. For example, the stored values may comprise historical values of the plurality of first-level variables and the plurality of first-level variable effects on the target variable may be identified based on changes in the historical values of the plurality of first-level variables. In some other embodiments, the plurality of first-level variable changes may be electronically selected, such as in a plurality of simulations. For example, the plurality of first-level variable effects may be identified by iterating through a range of values (e.g., sequentially or randomly), or algorithmically selecting a plurality of values for the plurality of first-level variables.

In some embodiments, at step/operation 404, the computing system 101 determines one or more first estimated effects on the target variable by configuring a first set of one or more first-level variables of the plurality of first-level variables based on the plurality of first-level variable effects.

In some embodiments, a estimated effect comprises a variable effect that comprises a highest relative degree of variable effect on a first variable (e.g., the target variable) that is caused by changing a second variable (e.g., a first-level variable from a plurality of first-level variables) to a given value among a plurality of values. In some embodiments, a estimated effect comprises a highest likelihood or probability of success. In some embodiments, a estimated effect comprises a cost that acts as a counter-balance.

In some embodiments, optimizing describes an operation for determining one or more values among a plurality of values for each of one or more first-level variables that cause a highest relative degree of variable effect (e.g., estimated effect) on a target variable. For example, the highest relative degree of variable effect on the second variable may be associated with a highest amount of desired effect on the second variable. According to various embodiments of the present disclosure, optimizing the first set of one or more first-level variables comprises, for each of the one or more first-level variables in the first set of one or more first-level variables, determining a value of the first-level variable that causes a greatest change (or rate of change) in the target variable based on the plurality of first-level variable effects. That is, the plurality of first-level variable effects (e.g., determined in step/operation 402) may be associated with a plurality of respective values of the plurality of first-level variables that provide one or more first estimated effects on the target variable. In some embodiments, the one or more first-level variables in the first set of one or more first-level variables are increased and/or decreased to provide the one or more first estimated effect on the target variable.

In some embodiments, at step/operation 406, the computing system 101 generates, using a target variable machine learning model, one or more first prediction outputs based on the one or more first estimated effects. Accordingly, the one or more first prediction outputs may comprise one or more first-level variable-based prediction outputs.

In some embodiments, a prediction output describes an output generated by a machine learning model. In some embodiments, a prediction output comprises a simulation that is based on one or more first estimated effects.

In some embodiments, a target variable machine learning model describes parameters, hyperparameters, and/or defined operations of a machine learning model that is configured to generate one or more prediction outputs that are associated with a target variable. In some embodiments, a target variable machine learning model is a PSEM. For example, the PSEM may define a set of associations among a set of variables. In some embodiments, a target variable machine learning model is configured to determine one or more relationships between one or more first-level variables and a target variable. In some examples, each of the associations and/or variables may be weighted by a plurality of learned coeffects. The learned coeffects may be configured through one or more training operations, such as supervised or unsupervised learning of training values for one or more first-level variables and a target variable to identify patterns such as clusters associated with the associations and/or variables. According to various embodiments of the present disclosure, a prediction output generated by a target variable machine learning model may comprise a value of a target variable that is determined, using one or more trained parameters, based on an optimization of one or more first-level variables based on one or more first-level variable effects on the target variable, wherein the one or more first-level variable effects are identified by varying the one or more first-level variables. In some embodiments, a target variable machine learning model is associated with Bayesian network analysis and is trained to determine an inference variable value based on one or more input variable values. In some embodiments, a target variable machine learning model comprises a probabilistic structural equation model, a supervised machine learning model, or an unsupervised machine learning model.

In some embodiments, a prediction output comprises a simulation that is based on one or more first estimated effects. For example, the one or more first prediction outputs may comprise one or more values of a target variable that are based on the first set of the one or more first-level variables comprising one or more values that are associated with the first estimated effects.

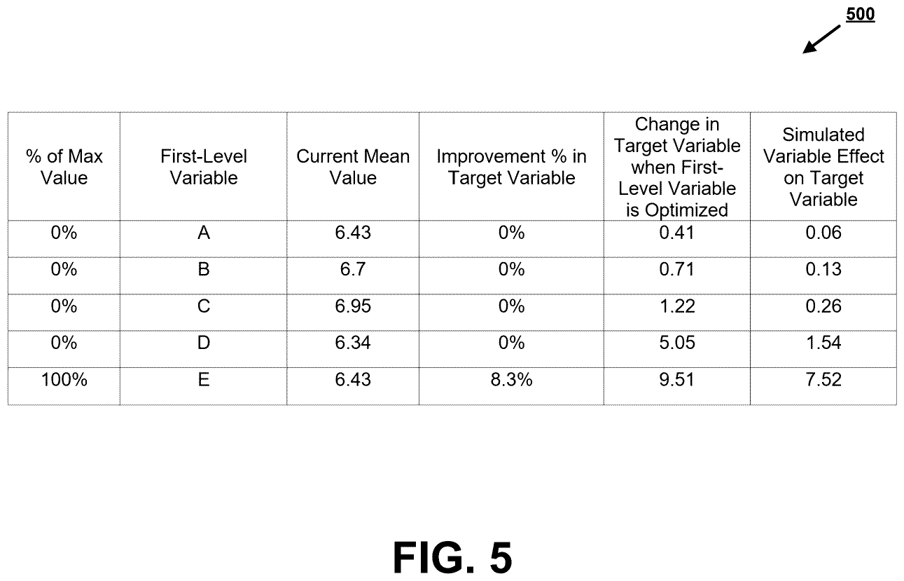

FIG. 5 is an operational example of a prediction output 500 in accordance with some embodiments of the present disclosure. As depicted in FIG. 5, the prediction output 500 comprises a plurality of simulated variable effects on a target variable based on an optimization of a plurality of first-level variables A, B, C, D, and E.

Returning to FIG. 4, in some embodiments, at step/operation 408, the computing system 101 generates a first set of combined prediction outputs by combining the one or more first prediction outputs with one or more second prediction outputs. In some embodiments, combining one or more first prediction outputs with one or more second prediction outputs may comprise associating the one or more first prediction outputs with the one or more second prediction outputs based on one or more relationships between one or more variables that are associated with the one or more first prediction outputs and one or more variables that are associated with the one or more second prediction outputs.

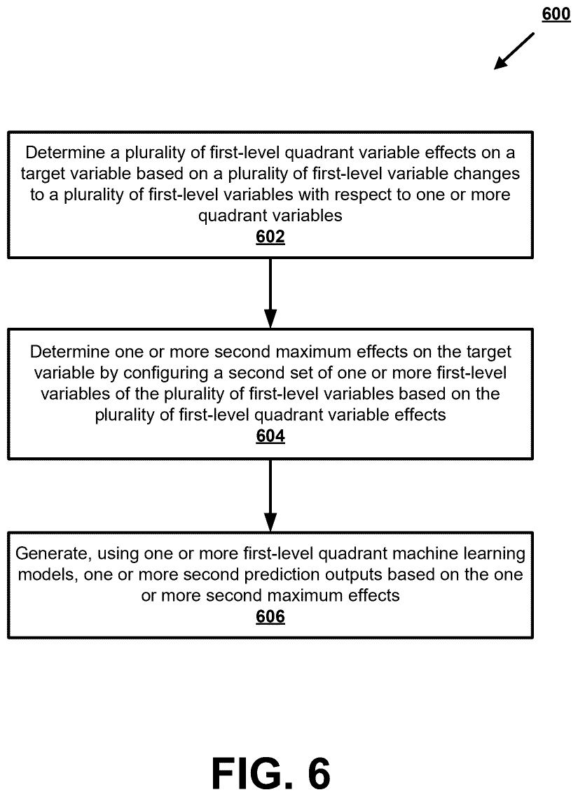

In some embodiments, the one or more second prediction outputs are generated based on one or more second estimated effects on the target variable with respect to one or more quadrant variables. Accordingly, the first set of combined prediction outputs may be representative of a multiple-model prediction output. Generating the one or more second prediction outputs are described in further detail with respect to the description of FIG. 6.

In some embodiments, a quadrant variable describes a segment of a target variable, also known as a breakout variable. For example, a quadrant variable may be associated with a subset of data that is associated with a target variable. In some embodiments, the one or more quadrant variables are associated with one or more data cohorts.

FIG. 6 is a flowchart diagram of an example process 600 for generating first-level quadrant variable-based prediction outputs in accordance with some embodiments of the present disclosure.

In some embodiments, the process 600 begins at step/operation 602 when the computing system 101 determines a plurality of first-level quadrant variable effects on a target variable based on a plurality of first-level variable changes to a plurality of first-level variables with respect to one or more quadrant variables. In some embodiments, the plurality of first-level quadrant variable changes may be determined based on stored values of the plurality of first-level variables. For example, the stored values may comprise historical values of the plurality of first-level variables and the plurality of first-level quadrant variable effects on the target variable may be identified based on changes in the historical values of the plurality of first-level variables that are specific to one or more quadrant variables. In some other embodiments, the plurality of first-level variable changes may be electronically selected, such as in a plurality of simulations. For example, the plurality of first-level quadrant variable effects may be identified by iterating through a range of values (e.g., sequentially or randomly), or algorithmically selecting a plurality of values for the plurality of first-level variables.

In some embodiments, at step/operation 604, the computing system 101 determines one or more second estimated effects on the target variable by configuring a second set of one or more first-level variables of the plurality of first-level variables based on the plurality of first-level quadrant variable effects. According to various embodiments of the present disclosure, optimizing the second set of one or more first-level variables comprises, for each of the one or more first-level variables in the second set, determining a value of the first-level variable that causes a greatest change (or rate of change) in the target variable and that is also specific to a quadrant variable. For example, the plurality of first-level quadrant variable effects (e.g., determined in step/operation 602) may be associated with a plurality of respective values of the plurality of first-level variables that provide one or more second estimated effects on the target variable that are specific to one or more quadrant variables. In some embodiments, the one or more first-level variables in the second set are increased and/or decreased to provide the one or more second estimated effect on the target variable.

In some embodiments, at step/operation 606, the computing system 101 generates, using one or more first-level quadrant machine learning models, one or more second prediction outputs based on the one or more second estimated effects. Accordingly, the one or more second prediction outputs may comprise a plurality of first-level quadrant variable-based prediction outputs.

In some embodiments, a first-level quadrant machine learning model describes parameters, hyperparameters, and/or defined operations of a machine learning model that is configured to generate one or more prediction outputs that are associated with a target variable and specific to a quadrant variable (e.g., first-level quadrant variable-based prediction outputs). In some embodiments, a first-level quadrant variable machine learning model is a PSEM. For example, the PSEM may define a set of associations among a set of variables. In some embodiments, a first-level quadrant machine learning model is configured to determine one or more relationships between one or more quadrant variables, one or more first-level variables, and a target variable. In some examples, each of the associations and/or variables may be weighted by a plurality of learned coeffects. The learned coeffects may be configured through one or more training operations, such as supervised or unsupervised learning of training values for one or more quadrant variables, one or more first-level variables, and a target variable to identify patterns such as clusters associated with the associations and/or variables. According to various embodiments of the present disclosure, a first-level quadrant variable machine learning model is configured to generate one or more prediction outputs based on one or more estimated effects on a target variable with respect to a quadrant variable. For example, a prediction output generated by a first-level quadrant variable machine learning model may comprise a value of a target variable that is specific to a quadrant variable and determined, using one or more trained parameters, based on an optimization of one or more first-level variables based on one or more first-level variable effects on the target variable, wherein the one or more first-level variable effects are identified by varying the one or more first-level variables. In some embodiments, a first-level quadrant variable machine learning model is associated with Bayesian network analysis and is trained to determine an inference variable value based on one or more input variable values (e.g., in view of a quadrant variable). In some embodiments, a first-level quadrant variable machine learning model comprises a probabilistic structural equation model, a supervised machine learning model, or an unsupervised machine learning model.

Returning to FIG. 4, in some embodiments, at step/operation 410, the computing system 101 initiates the performance of one or more prediction-based actions based on the first set of combined prediction outputs. Initiating the performance of the one or more prediction-based actions based on the first set of combined prediction outputs comprises, for example, performing a resource-based action (e.g., allocation of resource), generating a diagnostic report, generating and/or executing action scripts, generating alerts or messages, or generating one or more electronic communications. The one or more prediction-based actions may further include displaying visual renderings of the aforementioned examples of prediction-based actions in addition to values, charts, and representations associated with the first set of combined prediction outputs using a prediction output user interface.

In some embodiments, the performance of one or more prediction-based actions is initiated based on one or more of a first set of combined prediction outputs or a second set of combined prediction outputs. For example, the first set of combined prediction outputs may be associated with a plurality of first-level variables and the second set of combined prediction outputs may be associated with a plurality of second-level variables. According to some embodiments, (i) a simulation data object is generated based on one or more of the first set of combined prediction outputs or the second set of combined prediction outputs and (ii) the performance of the one or more prediction-based actions is initiated based on the simulation data object.

In some embodiments, a second-level variable describes a variable that contributes to or affects a value of a first-level variable. As such, in some example embodiments, initiating the performance of one or more prediction-based actions further comprises combining a plurality of sets of combined prediction outputs. Accordingly, one or more prediction outputs from a first set of combined prediction outputs may be cascaded with a second set of combined prediction outputs based on one or more relationships between a target variable, one or more first-level variables, or one or more second-level variables.

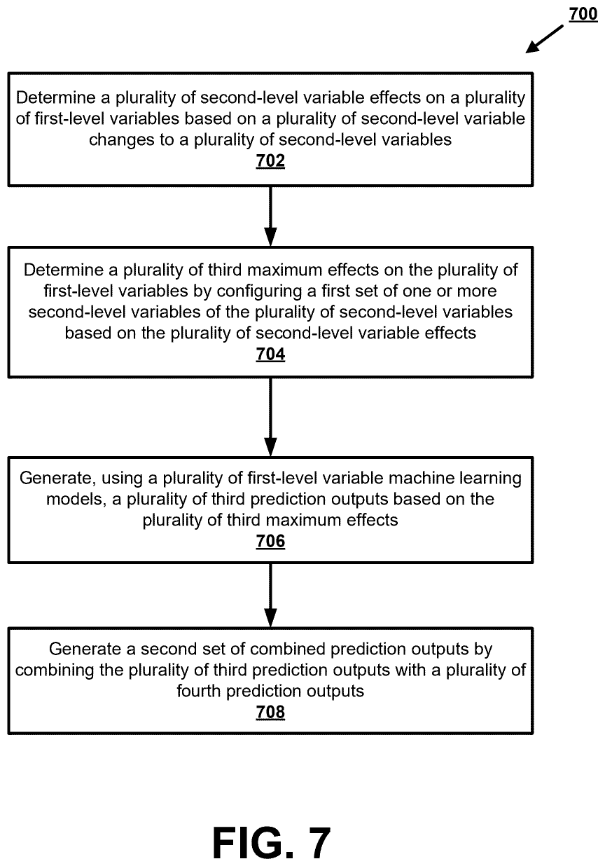

FIG. 7 is a flowchart diagram of an example process 700 for generating second-level variable-based prediction outputs in accordance with some embodiments of the present disclosure.

In some embodiments, the process 700 begins at step/operation 702 when the computing system 101 determines a plurality of second-level variable effects on a plurality of first-level variables based on a plurality of second-level variable changes to a plurality of second-level variables.

In some embodiments, a second-level variable change comprises a change of a second-level variable. For example, a second-level variable change may comprise an operation that varies a second-level variable for determining a second-level variable effect that is caused by varying the second-level variable.

In some embodiments, a plurality of second-level variable changes may be determined based on stored values of the plurality of second-level variables. For example, the stored values may comprise historical values of the plurality of second-level variables and a plurality of second-level variable effects on a plurality of first-level variables may be identified based on changes in the historical values of the plurality of second-level variables. In some other embodiments, the plurality of second-level variable changes may be electronically selected, such as in a plurality of simulations. For example, the plurality of second-level variable effects may be identified by iterating through a range of values (e.g., sequentially or randomly), or algorithmically selecting a plurality of values for the plurality of second-level variables.

In some embodiments, at step/operation 704, the computing system 101 determines a plurality of third estimated effects on the plurality of first-level variables by configuring a first set of one or more second-level variables of the plurality of second-level variables based on the plurality of second-level variable effects. According to various embodiments of the present disclosure, optimizing the first set of one or more second-level variables comprises, for each of the one or more second-level variables in the first set of one or more second-level variables, determining a value of the first-level variable that causes a greatest change (or rate of change) in a first-level variable based on the plurality of second-level variable effects. That is, the plurality of second-level variable effects (e.g., determined in step/operation 702) may be associated with a plurality of respective values of the plurality of second-level variables that provides the plurality of third estimated effects on the plurality of first-level variables. In some embodiments, the one or more second-level variables in the first set of one or more second-level variables are increased and/or decreased to provide the plurality of third estimated effects on the plurality of first-level variables.

In some embodiments, at step/operation 706, the computing system 101 generates, using a plurality of first-level variable machine learning models, a plurality of third prediction outputs based on the plurality of third estimated effects. Accordingly, the plurality of third prediction outputs may comprise a plurality of second-level variable-based prediction outputs.

In some embodiments, a first-level variable machine learning model describes parameters, hyperparameters, and/or defined operations of a machine learning model that is configured to generate one or more prediction outputs that are associated with a first-level variable. In some embodiments, a first-level variable machine learning model is a PSEM. For example, the PSEM may define a set of associations among a set of variables. In some embodiments, a first-level variable machine learning model is configured to determine one or more relationships between one or more second-level variables and a first-level variable. In some examples, each of the associations and/or variables may be weighted by a plurality of learned coeffects. The learned coeffects may be configured through one or more training operations, such as supervised or unsupervised learning of training values for one or more second-level variables and a first-level variable to identify patterns such as clusters associated with the associations and/or variables. According to various embodiments of the present disclosure, a prediction output generated by a first-level variable machine learning model may comprise a value of a first-level variable that is determined, using one or more trained parameters, based on an optimization of one or more second-level variables based on one or more second-level variable effects on the first-level variable that are associated with varying the one or more second-level variables. In some embodiments, a first-level variable machine learning model is associated with Bayesian network analysis and is trained to determine an inference variable value based on one or more input variable values. In some embodiments, a first-level variable machine learning model comprises a probabilistic structural equation model, a supervised machine learning model, or an unsupervised machine learning model.

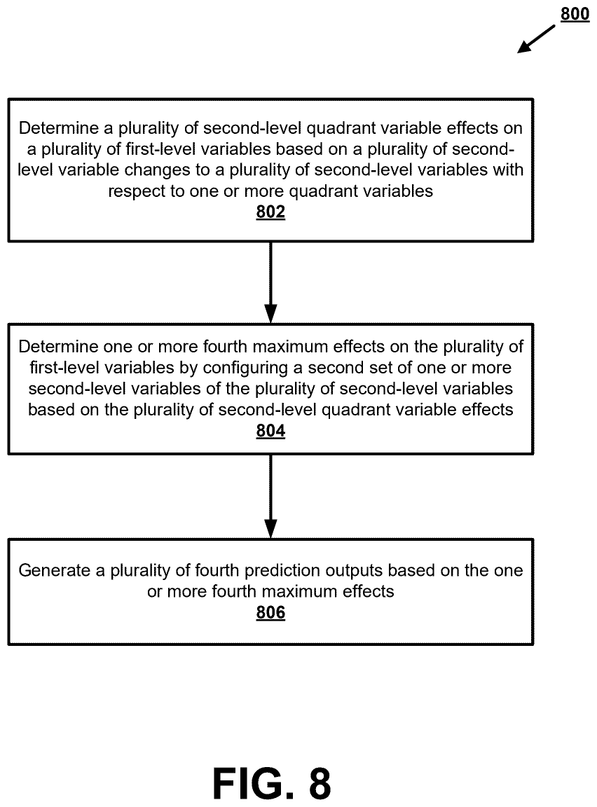

In some embodiments, at step/operation 708, the computing system 101 generates a second set of combined prediction outputs by combining the plurality of third prediction outputs with a plurality of fourth prediction outputs. In some embodiments, the plurality of fourth prediction outputs are generated based on one or more fourth estimated effects on the on the plurality of first-level variables with respect to one or more quadrant variables. Generating the plurality of fourth prediction outputs are described in further detail with respect to the description of FIG. 8.

FIG. 8 is a flowchart diagram of an example process 800 for generating second-level quadrant variable-based prediction outputs in accordance with some embodiments of the present disclosure.

In some embodiments, the process 800 begins at step/operation 802 when the computing system 101 determines a plurality of second-level quadrant variable effects on a plurality of first-level variables based on a plurality of second-level variable changes to a plurality of second-level variables with respect to one or more quadrant variables.

In some embodiments, the plurality of second-level quadrant variable changes may be determined based on stored values of the plurality of second-level variables. For example, the stored values may comprise historical values of the plurality of second-level variables and the plurality of second-level quadrant variable effects on the plurality of first-level variables may be identified based on changes in the historical values of the plurality of second-level variables that are specific to one or more quadrant variables. In some other embodiments, the plurality of second-level variable changes may be electronically selected, such as in a plurality of simulations. For example, the plurality of second-level quadrant variable effects may be identified by iterating through a range of values (e.g., sequentially or randomly), or algorithmically selecting a plurality of values for the plurality of second-level variables.

In some embodiments, at step/operation 804, the computing system 101 determines one or more fourth estimated effects on the plurality of first-level variables by configuring a second set of one or more second-level variables of the plurality of second-level variables based on the plurality of second-level quadrant variable effects. According to various embodiments of the present disclosure, optimizing the second set of one or more second-level variables comprises, for each of the one or more second-level variables in the second set of one or more second-level variables, determining a value of the second-level variable that causes a greatest change (or rate of change) in a first-level variable and that is also specific to a quadrant variable. For example, the plurality of second-level quadrant variable effects (e.g., determined in step/operation 802) may be associated with a plurality of respective values of the plurality of second-level variables that provide the one or more fourth estimated effects on the plurality of first-level variables that are specific to one or more quadrant variables. In some embodiments, the one or more second-level variables in the second set of one or more second-level variables are increased and/or decreased to provide the one or more fourth estimated effects on the plurality of first-level variables.

In some embodiments, at step/operation 806, the computing system 101 generates, using a plurality of second-level quadrant machine learning models, a plurality of fourth prediction outputs based on the one or more fourth estimated effects. Accordingly, the plurality of fourth prediction outputs may comprise a plurality of second-level quadrant variable-based prediction outputs.

In some embodiments, a second-level quadrant machine learning model describes parameters, hyperparameters, and/or defined operations of a machine learning model that is configured to generate one or more prediction outputs that are associated with a first-level variable and specific to a quadrant variable. In some embodiments, a second-level quadrant variable machine learning model is a PSEM. For example, the PSEM may define a set of associations among a set of variables. In some embodiments, a second-level quadrant machine learning model is configured to determine one or more relationships between one or more quadrant variables, one or more second-level variables, and a first-level variable. In some examples, each of the associations and/or variables may be weighted by a plurality of learned coeffects. The learned coeffects may be configured through one or more training operations, such as supervised or unsupervised learning of training values for one or more quadrant variables, one or more second-level variables, and a first-level variable to identify patterns such as clusters associated with the associations and/or variables. According to various embodiments of the present disclosure, a second-level quadrant variable machine learning model is configured to generate one or more prediction outputs based on one or more estimated effects on a first-level variable with respect to a quadrant variable. For example, a prediction output generated by a second-level quadrant variable machine learning model may comprise a value of a first-level variable that is specific to a quadrant variable and determined, using one or more trained parameters, based on an optimization of one or more second-level variables based on one or more second-level variable effects on the first-level variable, wherein the one or more second-level variable effects are identified by varying the one or more second-level variables. In some embodiments, a second-level quadrant variable machine learning model is associated with Bayesian network analysis and is trained to determine an inference variable value based on one or more input variable values (e.g., in view of a quadrant variable). In some embodiments, a second-level quadrant variable machine learning model comprises a probabilistic structural equation model, a supervised machine learning model, or an unsupervised machine learning model.

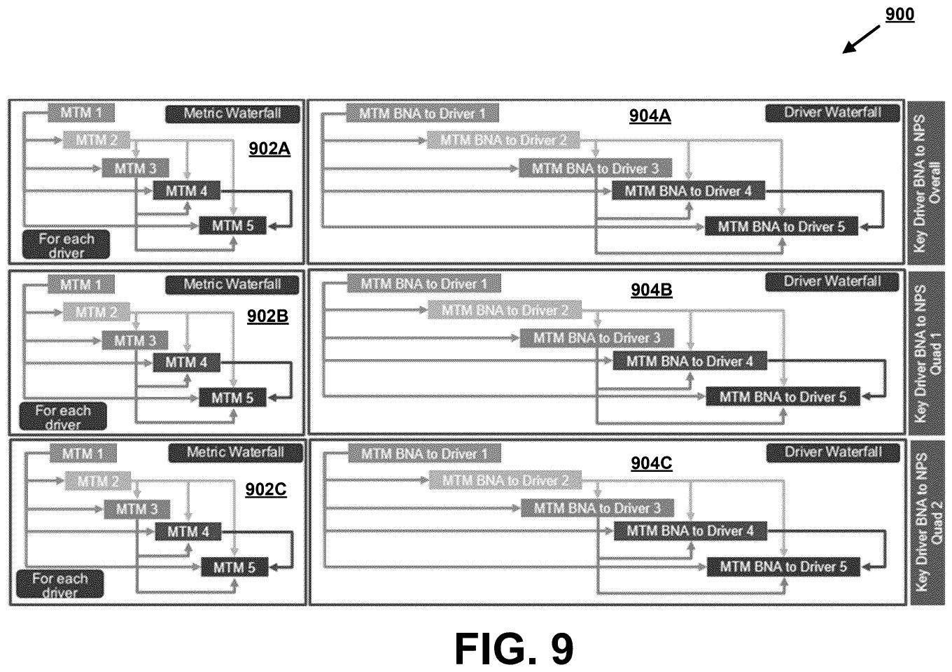

FIG. 9 is an operational example of sets of combined prediction outputs 900 in accordance with some embodiments of the present disclosure. A first set of combined prediction outputs 902A comprises a plurality of prediction outputs that are associated with a plurality of first-level variables. A second set of combined prediction outputs 904A comprises a plurality of prediction outputs that are associated with a plurality of second-level variables.

A third set of combined prediction outputs 902B comprises a plurality of prediction outputs that are associated with a plurality of first-level variables and specific to a first quadrant variable. A fourth set of combined prediction outputs 904B comprises a plurality of prediction outputs that are associated with a plurality of second-level variables and specific to a first quadrant variable.

A fifth set of combined prediction outputs 902C comprises a plurality of prediction outputs that are associated with a plurality of first-level variables and specific to a second quadrant variable. A sixth set of combined prediction outputs 904C comprises a plurality of prediction outputs that are associated with a plurality of second-level variables and specific to a second quadrant variable.

Embodiments of the present disclosure are not limited to the first-level variables, second-level variables, as well as the first set of combined prediction outputs and the second sets of combined prediction outputs disclosed herewith and are merely provided as examples. As understood by one of ordinary skill in the art, various embodiments of the present disclosure may be implemented with a plurality of variables and sets of combined prediction outputs beyond those described herewith.

Accordingly, as described above, various embodiments of the present disclosure make important technical contributions to multiple-model machine learning by extracting and isolating contributions from collinearity associated with a plurality of independent predictive machine learning models and reassembling the contributions such that the plurality of independent predictive machine learning models or predictions generated by the plurality of independent predictive machine learning models may be efficiently combined. This approach improves training speed and training efficiency of training predictive machine learning models as well as efficiency resulting from inferences performed by the predictive machine learning models (e.g., prioritize options and decisions). It is well-understood in the relevant art that there is typically a tradeoff between predictive accuracy and training speed, such that it is trivial to improve training speed by reducing predictive accuracy. Thus, the challenge is to improve training speed without sacrificing predictive accuracy through innovative machine learning model architectures. Accordingly, techniques that improve predictive accuracy without harming training speed, such as the techniques described herein, enable improving training speed given a constant predictive accuracy. In doing so, the techniques described herein improve efficiency and speed of training predictive machine learning models, thus reducing the number of computational operations needed and/or the amount of training data entries needed to train predictive machine learning models. Accordingly, the techniques described herein improve the computational efficiency, storage-wise efficiency, and/or speed of training machine learning models.

Some techniques of the present disclosure enable the generation of multiple-model-based prediction outputs that may be used to initiate one or more predictive actions to achieve real-world effects. The multiple-model combination techniques of the present disclosure may be used, applied, and/or otherwise leveraged to generate multiple-model-based prediction outputs by cascading sets of combined prediction outputs, which may help in the computer interpretation and association of a plurality of prediction outputs generated by a plurality of independent machine learning models. The multiple-model machine learning architecture of the present disclosure may be leveraged to initiate the performance of various computing tasks that improve the performance of a computing system (e.g., a computer itself, etc.) with respect to various predictive actions performed by the computing system 101, such as for the recommendation of improvements to a quality of a product or service and prediction of associated actions or resources that may be prioritized to improve the quality of the product or service, and/or the like.

In some examples, the computing tasks may include predictive actions that may be based on a prediction domain. A prediction domain may include any environment in which computing systems may be applied to achieve real-word insights, such as predictions (e.g., abstractive summaries, predictive intents, etc.), and initiate the performance of computing tasks, such as predictive actions (e.g., updating user preferences, providing account information, cancelling an account, adding an account, etc.) to act on the real-world insights. These predictive actions may cause real-world changes, for example, by controlling a hardware component, providing alerts, interactive actions, and/or the like.

Examples of prediction domains may include financial systems, clinical systems, autonomous systems, robotic systems, and/or the like. Predictive actions in such domains may include the initiation of automated instructions across and between devices, automated notifications, automated scheduling operations, automated precautionary actions, automated security actions, automated data processing actions, automated data compliance actions, automated data access enforcement actions, automated adjustments to computing and/or human data access management, and/or the like.

### VI. CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VII. EXAMPLES

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may include a single computing entity that is configured to perform all of the steps/operations of a particular example. In addition, or alternatively, a computing system may include multiple dedicated computing entities that are respectively configured to perform one or more of the steps/operations of a particular example. By way of example, the multiple dedicated computing entities may coordinate to perform all of the steps/operations of a particular example.

Example 1. A computer-implemented method comprising: determining, by one or more processors, a plurality of first-level variable effects on a target variable based on a plurality of first-level variable changes to a plurality of first-level variables; determining, by the one or more processors, one or more first estimated effects on the target variable by configuring a first set of one or more first-level variables of the plurality of first-level variables based on the plurality of first-level variable effects; generating, by the one or more processors and using a target variable machine learning model, one or more first prediction outputs based on the one or more first estimated effects; generating, by the one or more processors, a first set of combined prediction outputs by combining the one or more first prediction outputs with one or more second prediction outputs that are generated based on one or more second estimated effects on the target variable with respect to one or more quadrant variables; and initiating, by the one or more processors, the performance of one or more prediction-based actions based on the first set of combined prediction outputs.

Example 2. The computer-implemented method of example 1, further comprising: determining a plurality of first-level quadrant variable effects on the target variable based on the plurality of first-level variable changes to the plurality of first-level variables with respect to the one or more quadrant variables; determining the one or more second estimated effects on the target variable by configuring a second set of one or more first-level variables of the plurality of first-level variables based on the plurality of first-level quadrant variable effects; and generating, using one or more first-level quadrant machine learning models, the one or more second prediction outputs based on the one or more second estimated effects.

Example 3. The computer-implemented method of examples 1 or 2, further comprising: determining a plurality of second-level variable effects on the plurality of first-level variables based on a plurality of second-level variable changes to a plurality of second-level variables; determining a plurality of third estimated effects on the plurality of first-level variables by configuring a first set of one or more second-level variables of the plurality of second-level variables based on the plurality of second-level variable effects; generating, using a plurality of first-level variable machine learning models, a plurality of third prediction outputs based on the plurality of third estimated effects; and generating a second set of combined prediction outputs by combining the plurality of third prediction outputs with a plurality of fourth prediction outputs that are generated based on one or more fourth estimated effects on the plurality of first-level variables with respect to the one or more quadrant variables.

Example 4. The computer-implemented method of example 3 further comprising: determining a plurality of second-level quadrant variable effects on the plurality of first-level variables based on the plurality of second-level variable changes to the plurality of second-level variables with respect to the one or more quadrant variables; determining the one or more fourth estimated effects on the plurality of first-level variables by configuring a second set of one or more second-level variables of the plurality of second-level variables based on the plurality of second-level quadrant variable effects; and generating, using a plurality of second-level quadrant machine learning models, the plurality of fourth prediction outputs based on the one or more fourth estimated effects.

Example 5. The computer-implemented method of example 3 further comprising: generating a simulation data object based on one or more of the first set of combined prediction outputs or the second set of combined prediction outputs; and initiating the performance of the one or more prediction-based actions based on the simulation data object.

Example 6. The computer-implemented method of example 3, wherein the target variable machine learning model or at least one of the plurality of first-level variable machine learning models comprises a probabilistic structural equation model, a supervised machine learning model, or an unsupervised machine learning model.

Example 7. The computer-implemented method of any of the preceding examples, wherein the one or more first prediction outputs comprise one or more simulations that are based on the one or more first estimated effects.

Example 8. The computer-implemented method of any of the preceding examples, wherein the one or more second prediction outputs comprise one or more simulations that are based on the one or more second estimated effects.

Example 9. The computer-implemented method of any of the preceding examples, wherein the one or more quadrant variables are associated with one or more data cohorts.

Example 10. A computing system comprising memory and one or more processors communicatively coupled to the memory, the one or more processors configured to: determine a plurality of first-level variable effects on a target variable based on a plurality of first-level variable changes to a plurality of first-level variables; determine one or more first estimated effects on the target variable by configuring a first set of one or more first-level variables of the plurality of first-level variables based on the plurality of first-level variable effects; generate, using a target variable machine learning model, one or more first prediction outputs based on the one or more first estimated effects; generate a first set of combined prediction outputs by combining the one or more first prediction outputs with one or more second prediction outputs that are generated based on one or more second estimated effects on the target variable with respect to one or more quadrant variables; and initiate the performance of one or more prediction-based actions based on the first set of combined prediction outputs.

Example 11. The computing system of example 10, wherein the one or more processors are further configured to: determine a plurality of first-level quadrant variable effects on the target variable based on the plurality of first-level variable changes to the plurality of first-level variables with respect to the one or more quadrant variables; determine the one or more second estimated effects on the target variable by configuring a second set of one or more first-level variables of the plurality of first-level variables based on the plurality of first-level quadrant variable effects; and generate, using one or more first-level quadrant machine learning models, the one or more second prediction outputs based on the one or more second estimated effects.

Example 12. The computing system of examples 10 or 11, wherein the one or more processors are further configured to: determine a plurality of second-level variable effects on the plurality of first-level variables based on a plurality of second-level variable changes to a plurality of second-level variables; determine a plurality of third estimated effects on the plurality of first-level variables by configuring a first set of one or more second-level variables of the plurality of second-level variables based on the plurality of second-level variable effects; generate, using a plurality of first-level variable machine learning models, a plurality of third prediction outputs based on the plurality of third estimated effects; and generate a second set of combined prediction outputs by combining the plurality of third prediction outputs with a plurality of fourth prediction outputs that are generated based on one or more fourth estimated effects on the plurality of first-level variables with respect to the one or more quadrant variables.

Example 13. The computing system of example 12, wherein the one or more processors are further configured to: determine a plurality of second-level quadrant variable effects on the plurality of first-level variables based on the plurality of second-level variable changes to the plurality of second-level variables with respect to the one or more quadrant variables; determine the one or more fourth estimated effects on the plurality of first-level variables by configuring a second set of one or more second-level variables of the plurality of second-level variables based on the plurality of second-level quadrant variable effects; and generate, using a plurality of second-level quadrant machine learning models, the plurality of fourth prediction outputs based on the one or more fourth estimated effects.

Example 14. The computing system of example 12, wherein the one or more processors are further configured to: generate a simulation data object based on one or more of the first set of combined prediction outputs or the second set of combined prediction outputs; and initiate the performance of the one or more prediction-based actions based on the simulation data object.

Example 15. The computing system of example 12, wherein the target variable machine learning model or at least one of the plurality of first-level variable machine learning models comprises a probabilistic structural equation model, a supervised machine learning model, or an unsupervised machine learning model.

Example 16. One or more non-transitory computer-readable storage media including instructions that, when executed by one or more processors, cause the one or more processors to: determine a plurality of first-level variable effects on a target variable based on a plurality of first-level variable changes to a plurality of first-level variables; determine one or more first estimated effects on the target variable by configuring a first set of one or more first-level variables of the plurality of first-level variables based on the plurality of first-level variable effects; generate, using a target variable machine learning model, one or more first prediction outputs based on the one or more first estimated effects; generate a first set of combined prediction outputs by combining the one or more first prediction outputs with one or more second prediction outputs that are generated based on one or more second estimated effects on the target variable with respect to one or more quadrant variables; and initiate the performance of one or more prediction-based actions based on the first set of combined prediction outputs.

Example 17. The one or more non-transitory computer-readable storage media of example 16 further including instructions that, when executed by the one or more processors, cause the one or more processors to: determine a plurality of first-level quadrant variable effects on the target variable based on the plurality of first-level variable changes to the plurality of first-level variables with respect to the one or more quadrant variables; determine the one or more second estimated effects on the target variable by configuring a second set of one or more first-level variables of the plurality of first-level variables based on the plurality of first-level quadrant variable effects; and generate, using one or more first-level quadrant machine learning models, the one or more second prediction outputs based on the one or more second estimated effects.

Example 18. The one or more non-transitory computer-readable storage media of examples 16 or 17 further including instructions that, when executed by the one or more processors, cause the one or more processors to: determine a plurality of second-level variable effects on the plurality of first-level variables based on a plurality of second-level variable changes to a plurality of second-level variables; determine a plurality of third estimated effects on the plurality of first-level variables by configuring a first set of one or more second-level variables of the plurality of second-level variables based on the plurality of second-level variable effects; generate, using a plurality of first-level variable machine learning models, a plurality of third prediction outputs based on the plurality of third estimated effects; and generate a second set of combined prediction outputs by combining the plurality of third prediction outputs with a plurality of fourth prediction outputs that are generated based on one or more fourth estimated effects on the plurality of first-level variables with respect to the one or more quadrant variables.

Example 19. The one or more non-transitory computer-readable storage media of example 18 further including instructions that, when executed by the one or more processors, cause the one or more processors to: determine a plurality of second-level quadrant variable effects on the plurality of first-level variables based on the plurality of second-level variable changes to the plurality of second-level variables with respect to the one or more quadrant variables; determine the one or more fourth estimated effects on the plurality of first-level variables by configuring a second set of one or more second-level variables of the plurality of second-level variables based on the plurality of second-level quadrant variable effects; and generate, using a plurality of second-level quadrant machine learning models, the plurality of fourth prediction outputs based on the one or more fourth estimated effects.

Example 20. The one or more non-transitory computer-readable storage media of example 18 further including instructions that, when executed by the one or more processors, cause the one or more processors to: generate a simulation data object based on one or more of the first set of combined prediction outputs or the second set of combined prediction outputs; and initiate the performance of the one or more prediction-based actions based on the simulation data object.

Example 21. The computer-implemented method of example 6, further comprising training the target variable machine learning model or the at least one of the plurality of first-level variable machine learning models with training values for the target variable, the plurality of first-level variables, or the plurality of second-level variables to determine an inference variable value based on one or more input variable values.

Example 22. The computer-implemented method of example 21, wherein the training is performed by the one or more processors.

Example 23. The computer-implemented method of example 21, wherein the one or more processors are included in a first computing entity; and the training is performed by one or more other processors included in a second computing entity.

Example 24. The computer-implemented method of example 1, wherein the one or more processors are included in a first computing entity; and the generating of the one or more first prediction outputs is performed by one or more other processors included in a second computing entity.

Example 25. The computing system of example 15, wherein the one or more processors are further configured to train the target variable machine learning model or the at least one of the plurality of first-level variable machine learning models with training values for the target variable, the plurality of first-level variables, or the plurality of second-level variables to determine an inference variable value based on one or more input variable values.

Example 26. The computing system of example 25, wherein the training is performed by the one or more processors.

Example 27. The computing system of example 25, wherein the one or more processors are included in a first computing entity; and the training is performed by one or more other processors included in a second computing entity.

Example 28. The computing system of example 10, wherein the one or more processors are included in a first computing entity; and the generating of the one or more first prediction outputs is performed by one or more other processors included in a second computing entity.

Example 29. The one or more non-transitory computer-readable storage media of example 16 further including instructions that, when executed by the one or more processors, cause the one or more processors to train the target variable machine learning model or the at least one of the plurality of first-level variable machine learning models with training values for the target variable, the plurality of first-level variables, or the plurality of second-level variables to determine an inference variable value based on one or more input variable values.

Example 30. The one or more non-transitory computer-readable storage media of example 29, wherein the training is performed by the one or more processors.

Example 31. The one or more non-transitory computer-readable storage media of example 29, wherein the one or more processors are included in a first computing entity; and the training is performed by one or more other processors included in a second computing entity.

Example 32. The one or more non-transitory computer-readable storage media of example 16, wherein the one or more processors are included in a first computing entity; and the generating of the one or more first prediction outputs is performed by one or more other processors included in a second computing entity.

1. A computer-implemented method comprising:
determining, by one or more processors, a plurality of first-level variable effects on a target variable based on a plurality of first-level variable changes to a plurality of first-level variables;
determining, by the one or more processors, one or more first estimated effects on the target variable by configuring a first set of one or more first-level variables of the plurality of first-level variables based on the plurality of first-level variable effects;
generating, by the one or more processors and using a target variable machine learning model, one or more first prediction outputs based on the one or more first estimated effects;
generating, by the one or more processors, a first set of combined prediction outputs by combining the one or more first prediction outputs with one or more second prediction outputs that are generated based on one or more second estimated effects on the target variable with respect to one or more quadrant variables; and
initiating, by the one or more processors, the performance of one or more prediction-based actions based on the first set of combined prediction outputs.

2. The computer-implemented method of claim 1 further comprising:
determining a plurality of first-level quadrant variable effects on the target variable based on the plurality of first-level variable changes to the plurality of first-level variables with respect to the one or more quadrant variables;
determining the one or more second estimated effects on the target variable by configuring a second set of one or more first-level variables of the plurality of first-level variables based on the plurality of first-level quadrant variable effects; and
generating, using one or more first-level quadrant machine learning models, the one or more second prediction outputs based on the one or more second estimated effects.

3. The computer-implemented method of claim 1, further comprising:
determining a plurality of second-level variable effects on the plurality of first-level variables based on a plurality of second-level variable changes to a plurality of second-level variables;
determining a plurality of third estimated effects on the plurality of first-level variables by configuring a first set of one or more second-level variables of the plurality of second-level variables based on the plurality of second-level variable effects;
generating, using a plurality of first-level variable machine learning models, a plurality of third prediction outputs based on the plurality of third estimated effects; and
generating a second set of combined prediction outputs by combining the plurality of third prediction outputs with a plurality of fourth prediction outputs that are generated based on one or more fourth estimated effects on the plurality of first-level variables with respect to the one or more quadrant variables.

4. The computer-implemented method of claim 3 further comprising:
determining a plurality of second-level quadrant variable effects on the plurality of first-level variables based on the plurality of second-level variable changes to the plurality of second-level variables with respect to the one or more quadrant variables;
determining the one or more fourth estimated effects on the plurality of first-level variables by configuring a second set of one or more second-level variables of the plurality of second-level variables based on the plurality of second-level quadrant variable effects; and
generating, using a plurality of second-level quadrant machine learning models, the plurality of fourth prediction outputs based on the one or more fourth estimated effects.

5. The computer-implemented method of claim 3 further comprising:
generating a simulation data object based on one or more of the first set of combined prediction outputs or the second set of combined prediction outputs; and
initiating the performance of the one or more prediction-based actions based on the simulation data object.

6. The computer-implemented method of claim 3, wherein the target variable machine learning model or at least one of the plurality of first-level variable machine learning models comprises a probabilistic structural equation model, a supervised machine learning model, or an unsupervised machine learning model.

7. The computer-implemented method of claim 1, wherein the one or more first prediction outputs comprise one or more simulations that are based on the one or more first estimated effects.

8. The computer-implemented method of claim 1, wherein the one or more second prediction outputs comprise one or more simulations that are based on the one or more second estimated effects.

9. The computer-implemented method of claim 1, wherein the one or more quadrant variables are associated with one or more data cohorts.

10. A computing system comprising memory and one or more processors communicatively coupled to the memory, the one or more processors configured to:
determine a plurality of first-level variable effects on a target variable based on a plurality of first-level variable changes to a plurality of first-level variables;
determine one or more first estimated effects on the target variable by configuring a first set of one or more first-level variables of the plurality of first-level variables based on the plurality of first-level variable effects;
generate, using a target variable machine learning model, one or more first prediction outputs based on the one or more first estimated effects;
generate a first set of combined prediction outputs by combining the one or more first prediction outputs with one or more second prediction outputs that are generated based on one or more second estimated effects on the target variable with respect to one or more quadrant variables; and
initiate the performance of one or more prediction-based actions based on the first set of combined prediction outputs.

11. The computing system of claim 10, wherein the one or more processors are further configured to:
determine a plurality of first-level quadrant variable effects on the target variable based on the plurality of first-level variable changes to the plurality of first-level variables with respect to the one or more quadrant variables;
determine the one or more second estimated effects on the target variable by configuring a second set of one or more first-level variables of the plurality of first-level variables based on the plurality of first-level quadrant variable effects; and
generate, using one or more first-level quadrant machine learning models, the one or more second prediction outputs based on the one or more second estimated effects.

12. The computing system of claim 10, wherein the one or more processors are further configured to:
determine a plurality of second-level variable effects on the plurality of first-level variables based on a plurality of second-level variable changes to a plurality of second-level variables;
determine a plurality of third estimated effects on the plurality of first-level variables by configuring a first set of one or more second-level variables of the plurality of second-level variables based on the plurality of second-level variable effects;
generate, using a plurality of first-level variable machine learning models, a plurality of third prediction outputs based on the plurality of third estimated effects; and
generate a second set of combined prediction outputs by combining the plurality of third prediction outputs with a plurality of fourth prediction outputs that are generated based on one or more fourth estimated effects on the plurality of first-level variables with respect to the one or more quadrant variables.

13. The computing system of claim 12, wherein the one or more processors are further configured to:
determine a plurality of second-level quadrant variable effects on the plurality of first-level variables based on the plurality of second-level variable changes to the plurality of second-level variables with respect to the one or more quadrant variables;
determine the one or more fourth estimated effects on the plurality of first-level variables by configuring a second set of one or more second-level variables of the plurality of second-level variables based on the plurality of second-level quadrant variable effects; and
generate, using a plurality of second-level quadrant machine learning models, the plurality of fourth prediction outputs based on the one or more fourth estimated effects.

14. The computing system of claim 12, wherein the one or more processors are further configured to:
generate a simulation data object based on one or more of the first set of combined prediction outputs or the second set of combined prediction outputs; and
initiate the performance of the one or more prediction-based actions based on the simulation data object.

15. The computing system of claim 12, wherein the target variable machine learning model or at least one of the plurality of first-level variable machine learning models comprises a probabilistic structural equation model, a supervised machine learning model, or an unsupervised machine learning model.

16. One or more non-transitory computer-readable storage media including instructions that, when executed by one or more processors, cause the one or more processors to:
determine a plurality of first-level variable effects on a target variable based on a plurality of first-level variable changes to a plurality of first-level variables;
determine one or more first estimated effects on the target variable by configuring a first set of one or more first-level variables of the plurality of first-level variables based on the plurality of first-level variable effects;
generate, using a target variable machine learning model, one or more first prediction outputs based on the one or more first estimated effects;
generate a first set of combined prediction outputs by combining the one or more first prediction outputs with one or more second prediction outputs that are generated based on one or more second estimated effects on the target variable with respect to one or more quadrant variables; and
initiate the performance of one or more prediction-based actions based on the first set of combined prediction outputs.

17. The one or more non-transitory computer-readable storage media of claim 16 further including instructions that, when executed by the one or more processors, cause the one or more processors to:
determine a plurality of first-level quadrant variable effects on the target variable based on the plurality of first-level variable changes to the plurality of first-level variables with respect to the one or more quadrant variables;
determine the one or more second estimated effects on the target variable by configuring a second set of one or more first-level variables of the plurality of first-level variables based on the plurality of first-level quadrant variable effects; and
generate, using one or more first-level quadrant machine learning models, the one or more second prediction outputs based on the one or more second estimated effects.

18. The one or more non-transitory computer-readable storage media of claim 16 further including instructions that, when executed by the one or more processors, cause the one or more processors to:
determine a plurality of second-level variable effects on the plurality of first-level variables based on a plurality of second-level variable changes to a plurality of second-level variables;
determine a plurality of third estimated effects on the plurality of first-level variables by configuring a first set of one or more second-level variables of the plurality of second-level variables based on the plurality of second-level variable effects;
generate, using a plurality of first-level variable machine learning models, a plurality of third prediction outputs based on the plurality of third estimated effects; and
generate a second set of combined prediction outputs by combining the plurality of third prediction outputs with a plurality of fourth prediction outputs that are generated based on one or more fourth estimated effects on the plurality of first-level variables with respect to the one or more quadrant variables.

19. The one or more non-transitory computer-readable storage media of claim 18 further including instructions that, when executed by the one or more processors, cause the one or more processors to:
determine a plurality of second-level quadrant variable effects on the plurality of first-level variables based on the plurality of second-level variable changes to the plurality of second-level variables with respect to the one or more quadrant variables;
determine the one or more fourth estimated effects on the plurality of first-level variables by configuring a second set of one or more second-level variables of the plurality of second-level variables based on the plurality of second-level quadrant variable effects; and
generate, using a plurality of second-level quadrant machine learning models, the plurality of fourth prediction outputs based on the one or more fourth estimated effects.

20. The one or more non-transitory computer-readable storage media of claim 18 further including instructions that, when executed by the one or more processors, cause the one or more processors to:
generate a simulation data object based on one or more of the first set of combined prediction outputs or the second set of combined prediction outputs; and
initiate the performance of the one or more prediction-based actions based on the simulation data object.
